(19) United States
(12) Patent Application Publication
(10) Pub. No.: US 2011/0088945 A1
(43) Pub. Date: Apr. 21, 2011

(54) WIRE HARNESS AND PRODUCTION METHOD THEREFOR

(75) Inventors: Hiroshi Yanagimoto, Aichi-ken (JP); Takeshi Bessho, Aichi-ken (JP)

(73) Assignee: TOYOTA JIDOSHA KABUSHIKI KAISHA, Toyota-shi, Aichi-ken (JP)

(21) Appl. No.: 12/999,759

(22) PCT Filed: Jun. 16, 2009
(86) PCT No.: PCT/IB2009/005971

§ 371 Date: Dec. 17, 2010

(30) Foreign Application Priority Data
Jun. 19, 2008 (JP) 2008-161029

(51) Int. Cl. H02G 3/04; H01F 7/06

(52) U.S. Cl. 174/72 A; 29/605

(57) ABSTRACT

A wire harness has a wiring film which includes an insulating substrate (10), a plurality of wires (20) arranged on a surface of the insulating substrate (10), and an insulating covering (30) that coats the surface of the insulating substrate (10) so as to cover the wires (20). The wire harness is shaped by winding the wiring film around a longitudinal axis of a core (C), which is paralleled to the longitudinal axis (L) of the wires.

### BACKGROUND OF THE INVENTION

1. Field of the Invention

The present invention relates to a wire harness in which a plurality of wires arranged on an insulating substrate are bound together, and more specifically to a wire harness suitable for wiring in vehicles or the like and a production method for the wire harness.

2. Description of the Related Art

A large number of wires are required to be installed to drive electrical components mounted on automobiles or the like. Wire harnesses have been used to facilitate assembly work and wire arrangement in the vehicles during the installation.

Flat wire harnesses (so-called flat cables) are often used such as a flexible flat circuit and a flexible printed circuit, for example. In a flat cable, as shown in FIG. 4, for example, a plurality of wires 92 are arranged on a surface 91 a of a flexible insulating substrate 91 along a longitudinal direction L at predetermined intervals. An insulating covering 93 is protects the plurality of wires 92 and insulates the wires 92 (see Japanese Patent Application Publication No. 5-62543, for example).

By using the wire harness 90, a plurality of wires may be installed for electric components in an electrically insulated manner, even in locations where it is difficult to route a plurality of wires, not only improving the working efficiency but also enhancing the operational reliability of the electric components.

From the viewpoint of environmental resistance, however, it has been an issue to reduce the weight of wire harnesses in order to reduce the weight of vehicles. Thus, in an attempt to reduce the weight of flat wire harnesses, various approaches have been employed such as reusing the thickness of an insulating substrate or an insulating covering, for example, and changing the wire material from copper to aluminum, for example.

When such approaches are taken, however, several disadvantages may often be encountered even though the weight of the wire harness itself is reduced. For example, the wires of the wire harness may become inadequately insulated, a greater amount of heat may be produced, and the durability may be degraded, compared to those in the past.

If a flat wire harness is used, when it is desired to bend the wires 92, which are arranged along the longitudinal direction L, in a thickness direction T for wiring purposes, the wire harness can be bent in a bending direction b1 shown in

FIG. 4 to easily route the wires 92. When it is desired to bend the wires 92, which are arranged along the longitudinal direction L, in a width direction B for wiring purposes, however, it is difficult to bend the wire harness 90 in a bending direction b2 shown in FIG. 4 because of its shape. Thus, it is necessary to fold back the wire harness 90 itself in the thickness direction T (in the bending direction b1) as shown in FIG. 5 in order to route the wires 92.

In this case, the wire harness 90 may often be folded in an overlapping manner because of space restrictions in the components, which may fold the wires 92 so tightly as to be broken.

Especially if the insulating covering has been made thinner for weight reduction, an overlapped portion of the insulating covering may be worn by vibration of the components or the like during use, or may be folded so tightly as to be broken. In this case, the insulation between the wires may not be secured, or the wires may be short-circuited.

### SUMMARY OF THE INVENTION

The present invention provides a wire harness that allows wires to be easily routed in a desired direction without folding the wires so tightly and that reliably secures the insulation of the wires even if an attempt for weight reduction is made, and a production method for the wire harness.

A first aspect of the present invention provides a wire harness including a wiring film which includes an insulating substrate, a plurality of wires arranged on a surface of the insulating substrate, and an insulating covering that coats the surface of the insulating substrate so as to cover the wires. The wiring film is wound around a longitudinal axis of a core, which is parallel to a longitudinal axis of the wires, to form the wire harness.

According to the above first aspect, allowing precise arrangement of the wires inside the wire harness, the rolled wire harness can be easily bent in a desired direction. As a result, it is possible to avoid breakage of the wires when the wires are bent while being routed, and short-circuiting of the wires due to wear of the insulating covering or the like.

By coating the insulating substrate and the Wires with the insulating covering the wires arranged inside the wire harness may be insulated from each other. The insulating covering is arranged inside the wire harness. As a result, the insulating covering can be made thinner, facilitating weight reduction of the wire harness.

The term “wiring film” as used in the aspect of the invention refers to a film-like wiring board, which includes a sheet-like wiring board, in which a surface of an insulating substrate is coated with an insulating covering so as to cover at least exposed portions of a plurality of wires arranged in parallel in the longitudinal direction in order to maintain the insulation of the plurality of wires. The wire harness in accordance with the aspect of the invention is shaped by winding the wiring film.

In the above first aspect, grooves may be formed in the surface of the insulating substrate, and the wires may be arranged in the grooves. According to the above configuration, the wires can be arranged in the grooves formed in the surface of the insulating substrate, allowing weight reduction of the wire harness as well as more precise arrangement of the wires. Since the grooves are formed in the surface of the insulating substrate, the wiring film can be bent easily.

In the above aspect, the wiring film may be wound with openings of the grooves facing away from the longitudinal axis of the core. According to the above configuration, with the openings of the grooves formed to face away from the longitudinal axis of the core, it is easier to maintain the shape of the rolled wire harness, and it is less likely that the wires are subjected to bending stresses when the wire harness is bent during installation, compared to the case where the openings of the grooves are formed to face toward the longitudinal axis of the core the axis.

In the above aspect, the grooves may become wider from bottoms of the grooves toward the openings of the grooves. According to the above configuration, with the grooves becoming wider toward the surface of the insulating substrate, it is easy to maintain the rolled configuration of the wire harness.

In the above aspect, edges of the openings of the grooves and the bottoms of the grooves may be rounded. According to the above configuration, with the edges of the openings and the bottoms of the grooves rounded, stresses applied to the grooves and the wires in the vicinity of the grooves in the rolled wire harness can be relieved.

In the above aspect, the wiring file may be rolled around the longitudinal axis of the core. Alternatively, the wiring film may be wound around the longitudinal axis of the core in a multiplicity of layers.

In the above aspect, the wire harness may further include an insulating coating material that coats an outer peripheral surface of the wire harness. According to the above configuration, the wires can be coated with the insulating coating material for further protection, preventing short-circuiting of the wires due to wear and breakage of the wire harness during wiring and use.

A second aspect of the present invention provides a production method for a wire harness including arranging a plurality of wires on a surface of an insulating substrate, coating the surface of the insulating substrate with an insulating covering to cover the wires, and winding the wiring film around a longitudinal axis of a core, which is parallel to a longitudinal axis of the wires.

According to the above second aspect, since the wiring film is winding around the longitudinal axis of the core, in which the wires are arranged, the rolled wire harness can be fabricated without applying bending stresses to the wires. In addition, the rolled configuration allows precise arrangement of the wires along the longitudinal direction.

In the above second aspect, arranging the plurality of wires may include forming grooves in the surface of the insulating substrate, and arranging the wires in the grooves. According to the above aspect, with the grooves in which the wires are to be arranged formed in the longitudinal direction of the axis of the core, the wiring film can be made thinner, facilitating winding of the wiring film and allowing weight reduction of the wire harness.

In the above aspect, the wiring film may be wound with openings of the grooves facing away from the longitudinal axis of the core. According to the above aspect, since the rolled wire harness is shaped with the openings of the grooves facing away from the longitudinal axis of the core, local concentration of stresses applied to the wires while shaping the wire harness (while winding the wiring film) can be reduced, reliably avoiding breakage of the wires.

In the above aspect, the grooves may be shaped to become wider from bottoms of the grooves toward the openings of the grooves. In addition, the grooves may be shaped such that edges of the openings of the grooves and the bottoms of the grooves are rounded.

According to the above aspect, with the grooves becoming wider toward the surface of the insulating substrate, the wire harness can be easily wound. In addition, with the edges of the openings and the bottoms of the grooves rounded, stresses applied to the grooves and the wires in the vicinity of the grooves while winding the wiring film can be relieved.

In the above aspect, winding the wiring film may include rolling the wiring film around the longitudinal axis of the core. According to the above aspect, the rolled wire harness can be shaped from a single wiring film, reducing the production time and the production cost.

In the above aspect, winding the wiring film may include winding the wiring film around the longitudinal axis of the core in a multiplicity of layers. According to the above aspect, winding the wiring film in a multiplicity of layers allows more precise arrangement of the wires inside the wire harness.

In the above aspect, an insulating coating material may be coated on an outer peripheral surface of the wire harness after winding the wiring film.

This prevents short-circuiting of the wires more reliably.

According to the respective aspects of the present invention, wires can be easily routed in a desired direction without folding the wires so tightly, and the insulation of the wires can be secured even if an attempt for weight reduction is made.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIGS. 1A to 1D illustrate a production method for a wire harness in accordance with a first embodiment, in which

FIG 1A illustrates a step of arranging wires,

FIG. 1B illustrates a step of fabricating a wiring film,

FIG. 1C illustrates a step of rolling the wiring film, and

FIG 1D illustrates a step of coating a rolled wire harness with an insulating coating material, showing the overall configuration of the wire harness in accordance with the first embodiment;

FIGS. 2A to 2E illustrate the wire arranging step of the production method for a wire harness in accordance with FIG. 1A, in which

FIG. 2A illustrates a shaping die that shapes an insulating substrate,

FIG. 2B shows the shaping die whose surface is imparted with a conductive material layer,

FIG. 2C shows an insulating substrate to which the shaping die has been thermocompression-bonded to form grooves,

FIG. 2D shows the insulating substrate from which the shaping die has been detached, and

FIG. 2E shows the insulating substrate, on which wires are arranged by electroplating;

FIGS. 3A to 3D illustrate a production method for a wire harness in accordance with a second embodiment, in which

FIG. 3A illustrates a step of arranging wires,

FIG. 3B illustrates a step of fabricating a wiring film,

FIG. 3C illustrates a step of winding the wiring film in a multiplicity of layers, and

FIG. 3D illustrates a step of coating a rolled wire harness with an insulating coating material, showing the overall configuration of the wire harness in accordance with the second embodiment;

FIG. 4 shows a conventional flat wire harness; and

FIG. 5 shows the flat wire harness of FIG. 4 as bent in the width direction.

### DETAILED DESCRIPTION OF EMBODIMENTS

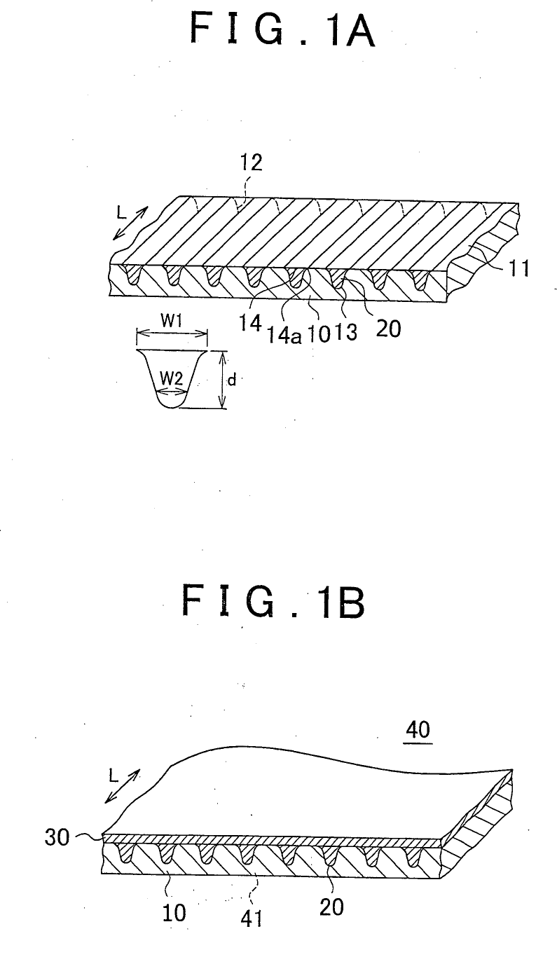

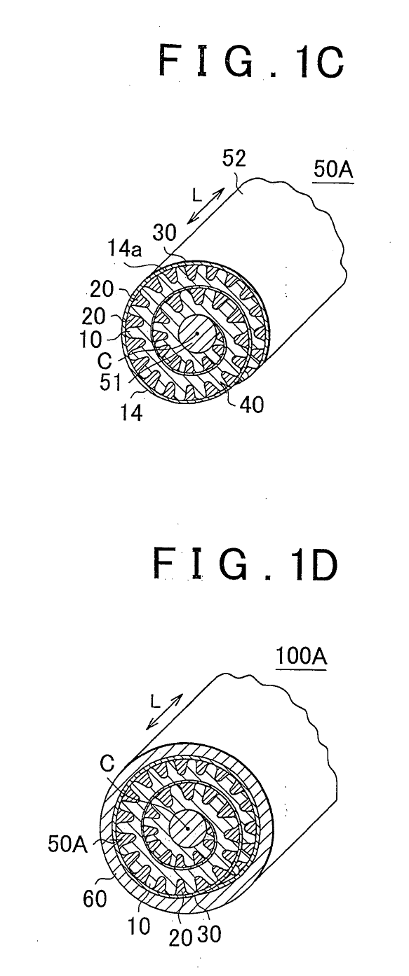

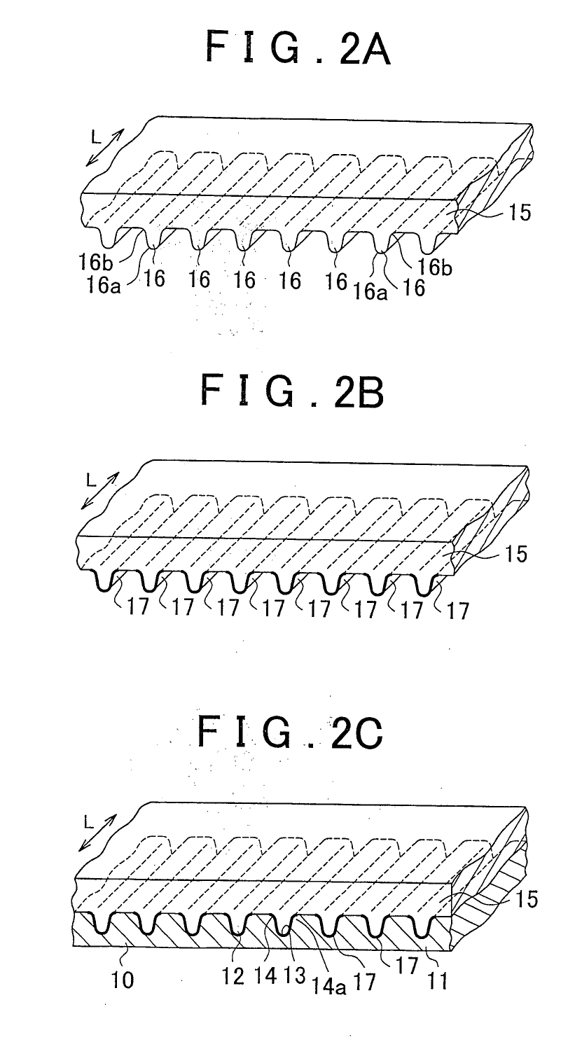

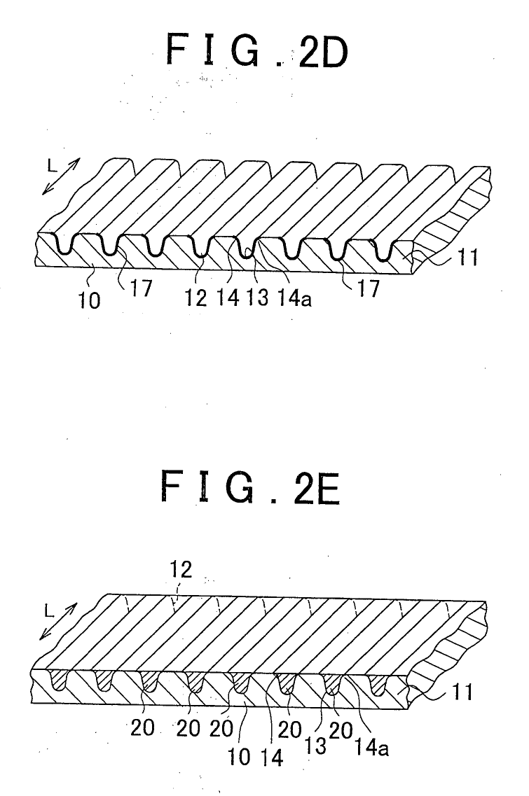

A method of producing a wire harness in accordance with a first embodiment is described based on FIGS. 1 and 2. The production method in accordance with this embodiment includes rolling (or winding) a wiring film which includes an insulating substrate 10, a plurality of wires 20 arranged on a surface 11 of the insulating substrate 10, and an insulating covering 30 that coats the surface 11 of the insulating substrate 10 and covers the exposed surfaces of the wires 20, to form a rolled wire harness. The production method also includes coating a surface of the rolled wire harness with an insulating coating material 60, fabricating the wire harness 100A (see FIG. 1D).

First, as shown in FIG. 1A, wires 20 are arranged in grooves 12 formed in insulating substrate film 10 along a longitudinal direction L. The grooves 12 are shaped to become wider from bottoms 13 toward openings 14 of the grooves 12. In addition, the grooves are shaped such that edges 14a of the openings 14 of the grooves 12 and the bottoms 13 of the grooves 12 are rounded. The edges 14a and the bottoms 13 are preferably rounded to be circular, with a predetermined radius of curvature, along the longitudinal direction L.

Specifically, as shown in FIG. 2A, a shaping die 15 is prepared, and projections 16 in accordance with the grooves 12 of the insulating substrate 10 are formed by electroforming, for example. The tips of the projections 16 are tapered toward projections 16. Tips 16a and bases 16b of the projections 16 are rounded. The projections 16 may each have a width of approximately 5 to 300 μm and a height of approximately 5 to 500 μm, and are arranged at intervals of approximately 5 to 300 μm.

Next, as shown in FIG. 2B, a copper paste mainly containing copper nanoparticles, which have an average particle diameter of 10 nm, is applied to the surface of the projections 16 of the obtained shaping die 15 to a thickness of approximately 3 μm to form conductive material layer 17.

Next, as shown in FIG. 2C, after the conductive material layer 17 is formed on the shaping die 15, the shaping die 15 is thermocompression-bonded to the surface 11 of an insulating substrate 10, such as a polyamic acid resin film with a thickness of 20 to 600 mm, in a vacuum environment using a micro-contact printing apparatus. Through the thermocompression-bonding, grooves 12 are formed the insulating substrate 10 at locations corresponding to the positions of the. projections 16 of the shaping die 15. Through this process, the copper nanoparticles contained in the copper paste become sintered and are transferred as a continuous copper thin film that extends from the bottom 13 to the edge 14a of the opening 14 of each groove 12. Then, the shaping die 15 is detached after the temperature and pressure return to normal, and as shown in FIG. 2D, the grooves 12 are formed in the surface 11 and the conductive material layers 17 is transferred to the grooves 12 as copper thin films.

After the transfer, the insulating substrate 10 is then immersed in a copper sulfate plating bath for electrolytic plating. Through this process, copper ions in the plating bath are deposited in the grooves 12 with-the conductive material layers 17 as nuclei, and as shown in FIG. 2E, wires 20 are formed in the grooves 12. Copper that has run over the grooves 12 may be removed by polishing.

As described above, the grooves 12 shown in FIG. 1A with an opening width W1 of approximately 5 to 300 μm, a depth d of 5 to 500 μm, and a near-bottom width W2 of 2 to 290 μm (in the case of a circular bottom, with a radius of curvature of 5 to 900 μm) are formed, and the copper wires 20 are arranged in the grooves 12.

It should be noted, however, that the present invention is not limited to the method shown in FIG. 2, and a plurality of wires may be arranged on a surface of an insulating substrate by any method such as a dry process such as a vacuum deposition method or a sputtering method, or a method including coating the entire surface of an insulating substrate with a metal film such as a copper foil to prepare a metal-coated material and removing unnecessary portions of the metal film by etching using a photolithographic method or the like. Wires may be directly arranged in grooves after the grooves are formed in a film-like insulating substrate.

The insulating substrate 10 may be made of a material with high flexibility and high electrical insulation, including polymer resins such as a polyimide, polyethylene naphthalate, polyethylene terephthalate or a polyethylene, for example. The wires 20 may be made of a metal material with low electrical resistance, including silver, gold, nickel, or aluminum, for example, besides copper discussed above.

Because the wires 20 may be arranged in the grooves 12 formed in the surface 11 of the insulating substrate 10, a wiring film, to be described later, may be made thinner, allowing weight reduction of the wire harness as well as more precise arrangement of the wires 20.

Next, as shown in FIG. 1B, the surface 11 of the insulating substrate 10 is coated with the insulating covering 30 so as to cover the exposed surfaces of the wires 20, fabricating a wiring film 40. Specifically, the surface 11 of the insulating substrate 10 with the wires 20 arranged in the grooves 12 may be coated with an adhesive such as an epoxy adhesive using a roll transfer method, or may be covered with a film-like insulating covering 30 made of the same material as the insulating substrate 10 using thermocompression-bonding, for example.

In this way, the wiring film 40, which has a thickness of approximately 22 to 700 μm, can be obtained. The wiring film 40 includes therein the insulating substrate 10, the plurality of wires 20 arranged on the surface 11 of the insulating substrate 10, and the insulating covering 30 that coats the insulating substrate 10 so as to cover the wires 20.

Further, as shown in FIG. 1C, the wiring film 40 is rolled about an axis C that extends in the longitudinal direction of the wires 20 formed in the wiring film 40 (longitudinal direction L) to form a rolled wire harness 50A. Specifically, an adhesive is applied to a surface 41 (cf. FIG. 1B) of the wiring film 40 on the insulating substrate 10 side, a cylindrical rod 51, made of the same material as the insulating substrate 10 is prepared, and the wiring film 40 is wound around the cylindrical rod 51. For example, the wiring film 40 may be rolled with the openings 14 of the grooves 12 facing away from the axis C (with the groove bottoms directed towards the axis C), thereby fabricating the rolled wire harness 50A. The wiring film 40 may be spirally rolled.

Because the rolled wire harness 50A is shaped with the openings 14 of the grooves 12 facing outward, local concentration of stresses applied to the wires 20 while shaping the wire harness 50A can be reduced, avoiding breakage of the wires 20. In addition, because the grooves 12 of the insulating substrate 10 are wider toward the surface 11 of the insulating substrate 10, the wiring film 40 may be easily rolled to fabricate the rolled wire harness 50A. With the edges 14a and the bottoms 13 of the grooves 12 rounded, stresses applied to the grooves 12 and the wires 20 in the vicinity of the grooves 12 may be relieved.

The adhesive to be applied to the surface 41 of the wiring film 40 on the insulating substrate 10 side may be made of a material with high insulation and high flexibility that provides good adhesion between the insulating substrate 10 and the insulating covering 30, including resins such as polyimide varnish, epoxy and, silicone.

Because the wiring film 40 is rolled around the axis C in the longitudinal direction of the wires 20 (longitudinal direction L) without cutting the wiring film 40, the rolled wire harness 50A may be easily fabricated without applying bending stresses to the wires 20. In addition, the rolled configuration allows precise arrangement of the wires 20 along the longitudinal direction L.

After the rolled wire harness 50A is formed, the surface (outer peripheral surface) 52 of the wire harness 50A is coated with an insulating coating material 60, as shown in FIG. 1D, to fabricate a wire harness 100A in accordance with this embodiment. The insulating coating material 60 may be made of the same material as the insulating substrate 10, and may be applied by a commonly known method for coating a metal wire with an insulating resin, such as wrapping a sheet-like insulating material around the outer peripheral surface 52 or processing the insulating coating material 60 together with the wire harness 50A using an extruder. The coating method is not specifically limited as long as the insulation of the fabricated wire harness 100A can be secured.

The insulating coating material 60 may be made of a material that is not cracked by external contact or being bent during handling of the wire harness 100A. Suitable materials may include polymer resins such as vinyl chloride, a polyimide, and a polyethylene, for example.

In the thus fabricated wire harness 100A, the wiring film 40 is wound around the axis C in the longitudinal direction of the wires 20 formed in the wiring film 40 (longitudinal direction L), allowing precise arrangement of the wires 20 inside the wire harness 100A.

The rolled wire harness 100A is easily bent in a desired direction by virtue of its shape. As a result, it is possible to avoid damaging the wires 20 when the wires 20 are bent during handling, and short-circuiting of the wires 20 due to wear of the insulating covering 30 or the like.

By coating the insulating substrate 10 and the wires 20 with the insulating covering 30 the wires 20 arranged inside the wire harness 100A may be insulted from each other. The insulating covering 30 is arranged inside the wire harness 100A. As a result, the insulating covering 30 can be made thinner, facilitating weight reduction of the wire harness 100A. In addition, the wire harness 100A can be easily bent in a desired direction by virtue of its rolled configuration.

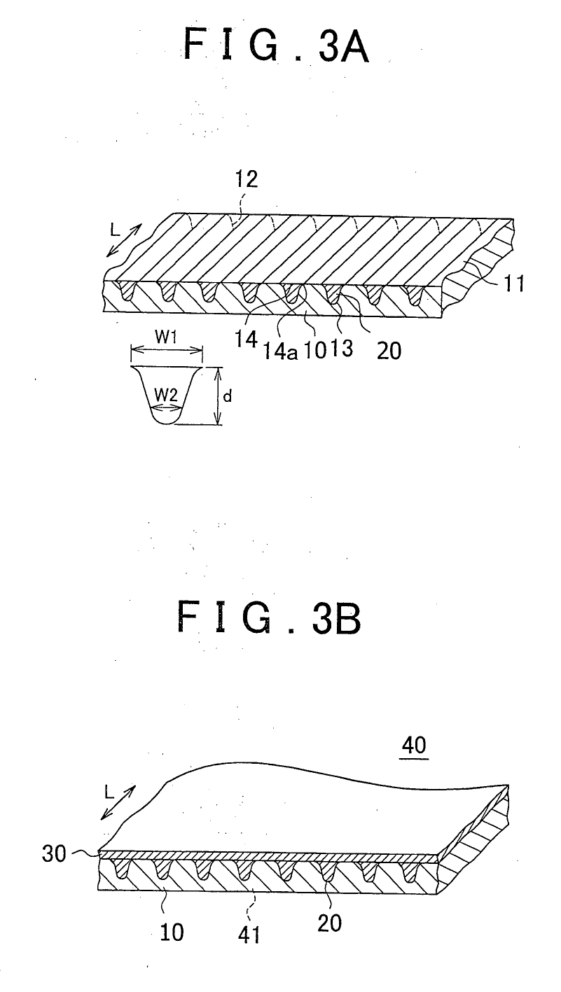

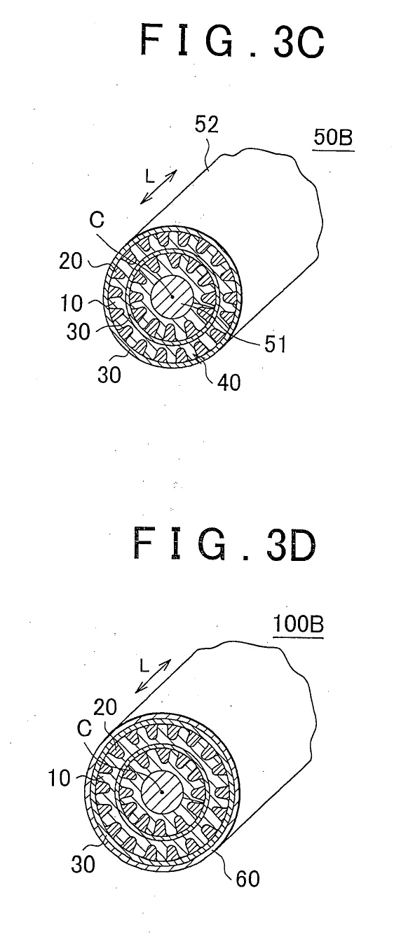

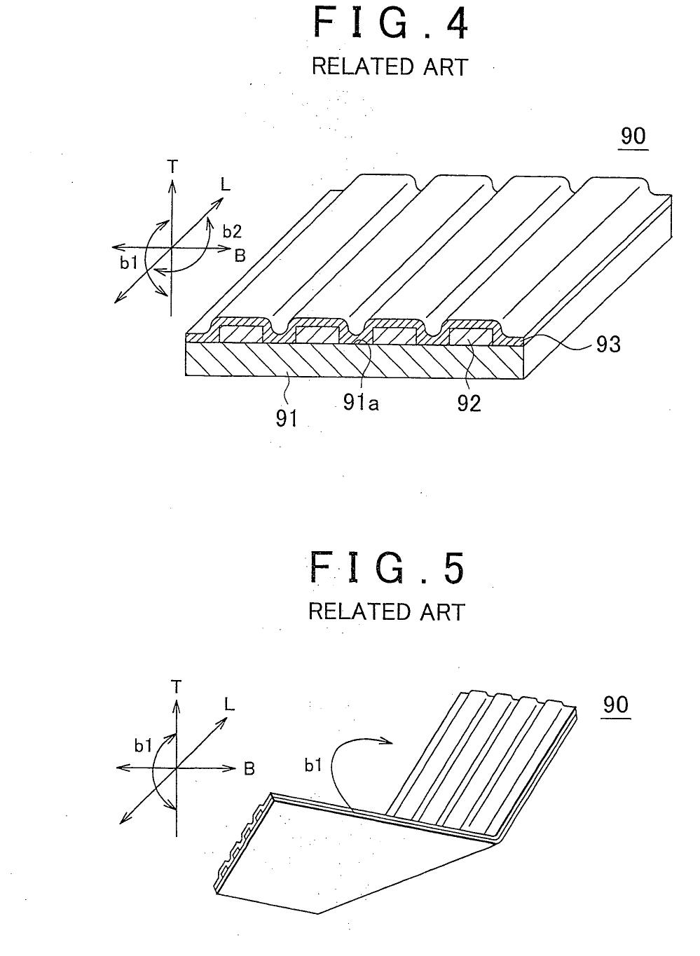

A second embodiment in accordance with the present invention will now be described with reference to FIG. 3. FIGS. 3A and 3B illustrate the same processes as those illustrated in FIGS. 1A and 1B, respectively, and where the same reference symbols are used, description of the indicated component will not be provided.

The second embodiment differs from the first embodiment in the step of winding (rolling) the wiring film. Specifically, as shown in FIG. 3C, the wiring film 40 is wound about an axis C that extends in the longitudinal direction of the wires formed in the wiring film 40 (longitudinal direction L). Specifically, an adhesive is applied to a surface 41 (cf. FIG. 3B) of the wiring film 40 on the side of insulating substrate 10, a cylindrical rod 51 made of the same material as the insulating substrate 10 is prepared, and the wiring film 40 is wound around the cylindrical rod 51 in a multiplicity of layers (two layers in the drawing) to form the rolled wire harness. Then, as shown in FIG. 3D, the rolled wire harness is coated with an insulating coat 60. In this way, the wiring film 40 is wound in a multiplicity of layers, and the outer peripheral surface of the rolled wiring film 40 is coated with the insulating coat 60, resulting in a wire harness 100B.

Although embodiments of the present invention have been described in detail above with reference to the drawings, the specific configuration of the present invention is not limited to the described embodiments. Rather, design changes may be made without departing from the scope of the present invention.

For example, although the wiring film is rolled (wound) around a cylindrical rod in both the first and second embodiments, the rod may have any shape as long as the wiring film can be rolled (wound). For example, an oval rod may be used in place of the cylindrical rod.

1. A wire harness comprising:
a wiring film which includes
an insulating substrate having a thickness;
grooves formed in the thickness of the insulating substrate,
a plurality of wires, each wire being entirely located within the volume of one of the grooves; and
an insulating covering that coats the surface of the insulating substrate so as to cover the wires,
wherein the wiring film is wound around a longitudinal axis of a core, which is parallel to a longitudinal axis of the wires, to form the wire harness.

2. The wire harness according to claim 1, wherein the volumes of the grooves are closed by the insulating covering.

3. The wire harness according to claim 1, wherein the wiring film is wound with openings of the grooves facing away from the longitudinal axis of the core.

4. The wire harness according to claim 1, wherein the grooves become wider from the bottoms of the grooves toward the openings of the grooves.

5. The wire harness according to claim 4, wherein edges of the openings of the grooves and the bottoms of the grooves are rounded.

6. The wire harness according to claim 1, wherein the wiring film is rolled around the longitudinal axis of the core.

7. The wire harness according to claim 1, wherein the wiring film is wound around the longitudinal axis of the core in a multiplicity of layers.

8. The wire harness according to claim 1, further comprising an insulating coating material that coats an outer peripheral surface of the wire harness.

9. A production method for a wire harness, comprising:
forming grooves in the thickness of an insulating substrate,
entirely locating each wire of a plurality of wires within the volume of one of the grooves;
coating the surface of the insulating substrate with an insulating covering to cover the wires; and
winding the wiring film around a longitudinal axis of a core, which is parallel to a longitudinal axis of the wires.

10. The production method according to claim 9, wherein the volumes of the grooves are closed by the insulating covering.

11. The production method according to claim 9, wherein the wiring film is wound with openings of the grooves facing away from the longitudinal axis of

12. The production method according to claim 9, wherein the grooves are shaped to become wider from the bottoms of the grooves toward the openings of the grooves.

13. The production method according to claim 12, wherein the grooves are shaped so that the edges of the openings of the grooves and the bottoms of the grooves are rounded.

14. The production method according to claim 9, wherein winding the wiring film includes rolling the wiring film around the longitudinal axis of the core.

15. The production method according to claim 9, wherein winding the wiring film includes winding the wiring film around the longitudinal axis of the core in a multiplicity of layers,

16. The production method according to claim 9, wherein an insulating coating material is coated on an outer peripheral surface of the wire harness after winding the wiring film.
